(19) United States
(12) Patent Application Publication
(10) Pub. No.: US 2015/0196841 A1
(43) Pub. Date: Jul. 16, 2015

(54) LOAD BALANCING SYSTEM AND METHOD FOR RENDERING SERVICE IN CLOUD GAMING ENVIRONMENT

(71) Applicant: Electronics and Telecommunications Research Institute, Daejeon (KR)

(72) Inventor: Won-Jae LEE, Daejeon-si (KR)

(21) Appl. No.: 14/295,759

(22) Filed: Jun. 4, 2014

(30) Foreign Application Priority Data
Jan. 15, 2014 (KR) 10-2014-0005190

(51) Int. Cl. A63F 13/355; H04L 12/26; H04L 29/08

(52) U.S. Cl. CPC A63F 13/355; H04L 67/1002; H04L 43/04

(57) ABSTRACT

A load balancing system and method for a rendering service in a cloud gaming environment. In predicting load of servers and allocating a game to a specific server, the load balancing system and method may provide users with an appropriate rendering speed for each game, thereby enabling a satisfactory game service to be provided and efficient use of limited resources.

### CROSS-REFERENCE TO RELATED APPLICATION(S)

This application claims the benefit under 35 U.S.C. §119(a) of Korean Patent Application No. 10-2014-0005190, filed on Jan. 15, 2014, in the Korean Intellectual Property Office, the entire disclosure of which is incorporated herein by reference for all purposes.

### BACKGROUND

1. Field

The following description relates to a load balancing technology, and more specifically, to a load balancing system and method for a rendering service in a cloud gaming environment

2. Description of the Related Art

It is necessary to balance the load on a plurality of servers for providing a great amount of users with a real-time rendering service. The load balancing technology of a game server is written in Korean Laid-open Patent Publication No. 10-2011-0136079 (published on Dec. 21, 2011), and the like. However, since the existing load balancing technology is not capable of using properties of cloud gaming service request and states of cloud gaming servers, wherein the cloud gaming service is a type of a real-time rendering service, optimal load-balancing has not been possible.

In a case of cloud gaming, if a service where a screen is rendered and encoded in an appropriate frames per second (FPS) for each game, a user's satisfaction may decline or an unnecessary amount of resources may be consumed. In addition, in the case of the cloud gaming, resources that each user consumes are large and predictable, thereby preventing a specific server from an overload state. Furthermore, executing the same game in one server may increase the cash utilization which can lead to an efficient usage of server resources.

### SUMMARY

The following description relates to a technology for the purpose of providing a load balancing system and method for rendering service in cloud gaming environment to, when distributing requests for a real-time rendering service to several servers in the cloud gaming environment, distribute the requests to the servers enough to execute the game at a high enough speed to thereby execute each game at an appropriate speed.

To that end, in one general aspect, a load balancing system for a rendering service in a cloud gaming environment includes a load balancer to select, based on a load state of each server and anticipatory resources consumption for each game, a server where a game which has been requested to be executed by a client device is to be allocated, and transmit, to the client device, information on the selected server and rendering speed information on a game screen rendered in the selected server; and a monitoring server to monitor a game, which is being serviced by each server, and a load state of each server, and provide information on the monitored game and information on the monitored load state to the load balancer.

The load balancer may include an information collector to collect the information on the game, which is being serviced by each server, and the information on the load state of each server from the monitoring server; information storage to store the information on the game, which is being serviced by each server, and the information on the load state of each server, wherein both are collected by the information collector; a resources consumption predictor to, based on the information on the load state of each server, which has been stored in the information storage, predict the anticipatory resources consumption that is to be expected when the game, which has been requested to be executed by the client device, is to be allocated to each server; and a server selector to select a server with minimum load based on the anticipatory resources consumption predicted by the resources consumption predictor.

The server selector may transmit information on the selected server with minimum load to the client device which has requested to execute the game.

The server selector may further transmit the rendering speed information on the game of the selected server with minimum load to the client device which has requested to execute the game.

The information on the game may include unique game identification information for identifying each game; consumed Central Processing Unit (CPU) capacity information of a time when each game is allocated to each server; consumed Graphics Processing Unit (GPU) capacity information of the time when each game is allocated to the server; consumed memory capacity information of the time when each game is allocated to the server; consumed network capacity information of the time when each game is allocated to the server; and rendering speed information of the time when each game is allocated to the server.

The information on the load state may include unique server identification information for identifying each server; IP address information in which IP addresses of each server are recorded; CPU information in which CPU capacity and CPU load of each server are recorded; GPU information in which GPU capacity and GPU load of each server are recorded; memory information in which memory capacity and memory usage of each server are recorded; network information in which network capacity and network usage of each server are recorded; and game allocation information in which recorded are game identification information of a game allocated at present to each server, rendering speed information of the allocated game, and client identification information for identifying the client device which has requested to execute the allocated game.

The server selector may predict capacity of available resources of each server based on resources consumption that is to be expected when the game, which has been requested to be executed by the client device, is allocated to each server; and select a server, which has been predicted to have maximum capacity of available resources, as a server with the minimum load.

The server selector may transmit frame per second (FPS) information for each game as the rendering speed information.

The rendering speed information may be set in advance.

The resources consumption predictor may further reflect information of a reserved game whose load has not yet been monitored although the game has already been allocated to each server; and predict the anticipatory resources consumption that is to be expected when the game, which has been requested to be executed by the client device, is allocated to each server.

The reserved game information may include server identification information on a server where the reserved game is to be allocated; game identification information on the reserved game; and client identification information on the client device which has requested to execute the reserved game.

In another general aspect, a load balancing method for a rendering service in a cloud gaming environment includes monitoring, by a monitoring server, a game being serviced by each server and a load state of each server; providing, by the monitoring server, monitored information on the game and monitored information on the load state to a load balancer; collecting, by the load balancer, the information on the game and the information on the load state from the monitoring server; storing, by the load balancer, the collected information on the game and the collected information on the load state; receiving, by the load balancer, a request for an execution of a specific game from a client device; based on the stored information of the load state, predicting, by the load balancer, anticipatory resources consumption that is to be expected when the game which has been requested to be executed is allocated to each server; selecting, by the load balancer, a server with minimum load based on the predicted resources consumption of a time when the game which has been requested to be executed is allocated to each server; and transmitting, by the load balancer, information on the selected server and rendering speed information on a game screen rendered in the selected server to the client device.

When predicting load of servers and allocating a game to a specific server, exemplary embodiments of a load balancing system for a rendering service in a cloud gaming environment provides an appropriate rendering speed for each game, thereby providing users with a satisfactory game service and enabling efficient use of limited resources.

### BRIEF DESCRIPTION OF THE DRAWINGS

FIG. 1 is a diagram illustrating an example of a load balancing system for a rendering service in a cloud gaming environment according to an exemplary embodiment.

FIG. 2 is a diagram illustrating an example of a load balancer of a load balancing system for a rendering service in a cloud gaming environment according to an exemplary embodiment.

FIG. 3 is a diagram illustrating an example of game information being serviced by each server according to an exemplary embodiment.

FIG. 4 is a diagram illustrating an example of load state information of a server according to an exemplary embodiment.

FIG. 5 is a diagram illustrating an example of reserved game information according to an exemplary embodiment.

FIG. 6 is a flowchart illustrating an example of a load balancing method of a load balancing system for a rendering service in a cloud gaming environment according to an exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

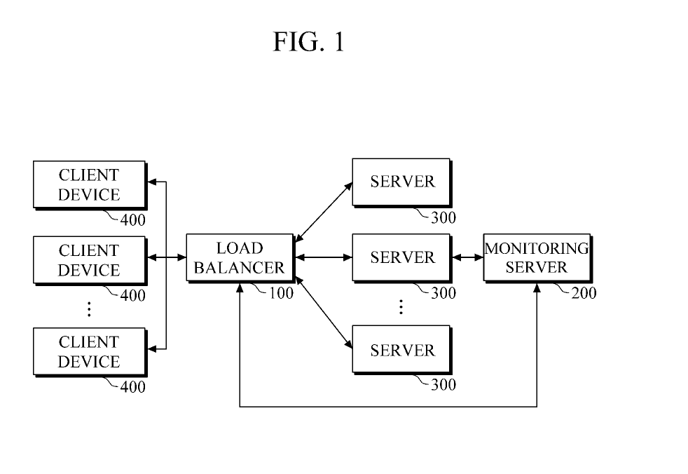

FIG. 1 is a diagram illustrating an example of a load balancing system for a rendering service in a cloud gaming environment according to an exemplary embodiment. As illustrated in FIG. 1, a load balancing system for a rendering service in a cloud gaming environment includes a load balancer 100 and a monitoring server 200. The load balancer 100 and the monitoring server 200 may be implemented to be logically separated within one physical device, or each may be implemented to be physically separated within two devices.

The load balancer 100 works in association with a plurality of servers 300 and a plurality of client devices 400. Thus, according to a load state of each of the servers 300 and an anticipatory amount of resources to be consumed (hereinafter, referred to as anticipatory resources consumption) for each game, the load balancer 100 selects a server where a game, which has been requested to be executed by the client device 400, is to be allocated. Then, the load balancer 100 transmits, to the client device 400, the selected server information and rendering speed information of the game screen rendered in the selected server.

The monitoring server 200 works in association with the plurality of servers 300, and monitors a game being serviced by each of the servers 300, and a load state of each of the servers 300. Then, the monitoring server 200 provides, to the load balancer 100, the monitored game information being serviced by each server, and the monitored load state information of each server. Here, the monitoring server 200 may be implemented to periodically or non-periodically transmit, to the load balancer 100, the monitored game information being serviced by each server and the monitored load state information of each server.

By such an implement, in predicting load of the server and allocating a game to a specific server, the load balancing system provide the client device 400 with an appropriate rendering speed for each game, thereby providing users with a satisfactory game service and enabling efficient use of limited resources.

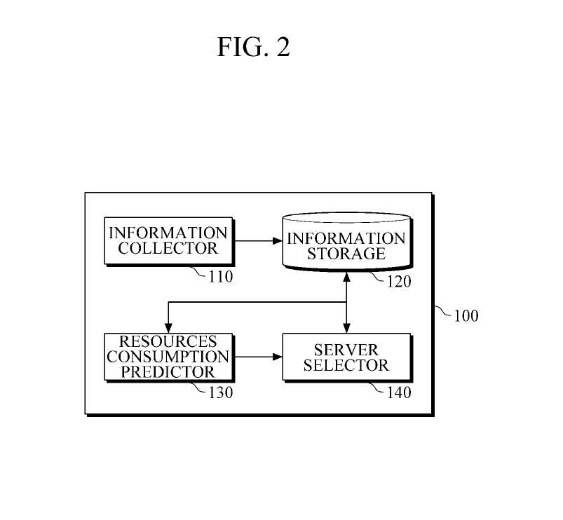

FIG. 2 is a diagram illustrating an example of a load balancer of a load balancing system for a rendering service in a cloud gaming environment according to an exemplary embodiment. As illustrated in FIG. 2, a load balancer 100 according to an exemplary embodiment includes an information collector 110, information storage 120, a resources consumption predictor 130, and a server selector 140.

The information collector 110 collects, from a monitoring server 200, game information, which is being serviced by each of the servers 300, and load state information of each of the servers 300. If the game information being serviced by each server and the load state information of each server, which both have been monitored by the monitoring server 200, are periodically or non-periodically transmitted, the information collector 110 collects the transmitted game information and the transmitted load state information.

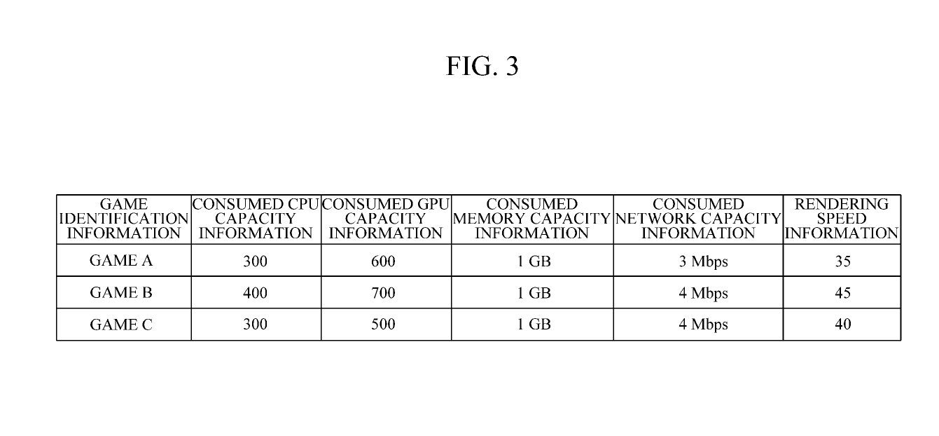

The information storage 120 stores the game information being serviced by each of the servers 300, and the load state information of each of the servers 300, which have been collected by the information collector 110. For example, the game information, which is being serviced by each server and has been stored by the information storage 120, may be implemented as illustrated in FIG. 3.

FIG. 3 is a diagram illustrating an example of game information being serviced by each server according to an exemplary embodiment. The game information includes unique game identification information for identifying each game, and it also includes consumed Central Processing Unit (CPU) capacity information of the time when each game is allocated to the server; consumed Graphics Processing Unit (GPU) capacity information of the time when each game is allocated to the server; consumed memory capacity information of the time when each game is allocated to the server; consumed network capacity information of the time when each game is allocated to the server; and rendering speed information of the time when each game is allocated to the server.

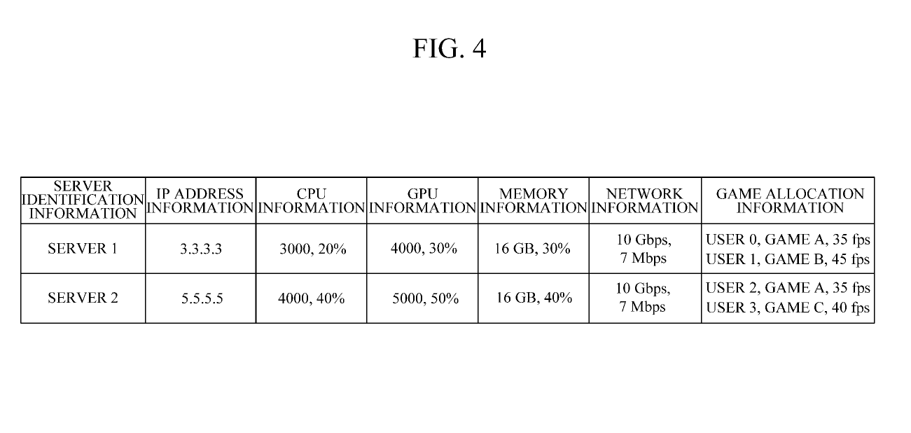

For example, load state information of a server stored by information storage 120 may be implemented as illustrated in FIG. 4. FIG. 4 is a diagram illustrating an example of load state information of a server according to an exemplary embodiment. The load state information of the server includes: unique server identification information for identifying each server; IP address information in which IP addresses of each server are recorded; CPU information in which CPU capacity and CPU load of each server are recorded; GPU information in which GPU capacity and GPU load of each server are recorded; memory information in which memory capacity and memory usage of each server are recorded; network information in which network capacity and network usage of each server are recorded; and game allocation information in which recorded are game identification information of a game allocated at present to each server, rendering speed information of the allocated game, and client identification information for identifying a client device which has requested to execute the allocated game.

A resources consumption predictor 130 predicts, based on load state information of each of the servers 300 stored in the information storage 120, anticipatory resources consumption that is to be expected when a game, which has been requested to be executed by a client device 400, is allocated to each of the servers 300.

For example, the resources consumption predictor 130 may be implemented to give a first score of 0 to each of the servers 300; detect a current load amount of each of the servers 300 by using the load state information of each of the servers 300 stored in the information storage 120; change scores of each server according to the amount of load changed in a case where a game which has been requested to be executed by the client device 400 is newly allocated to each of the servers 300; and predict the resources consumption.

In another example, the resources consumption predictor 130 may be implemented to subtract 40 scores from a present score of each server if CPU load is greater than or equal to 80% and less than 90% which is changed in a case where the game, which has been requested to be executed by the client device 400, is newly allocated to each of the servers 300; or to subtract 100 scores from the present score of each server if the CPU load is greater than or equal to 90%, thereby changing the scores of each server.

In yet another example, the resources consumption predictor 130 may be implemented to subtract 20 scores from the present score of each server if GPU load is greater than or equal to 70% and less than 80% which is changed in a case where the game, which has been requested to be executed by the client device 400, is newly allocated to each of the servers 300; to subtract 40 scores from the present score of each server if greater than or equal to 80% and less than 90%; or to subtract 100 scores from the present score of each server if greater than or equal to 90%, thereby changing the scores of each server.

In yet another example, the resources consumption predictor 130 may be implemented to add 20 scores to the present score of each server if available memory capacity, i.e. the capacity of available memory, is greater than or equal to 1 GB, which is changed in a case where the game, which has been requested to be executed by the client device 400, is newly allocated to each of the servers 300; or to subtract 100 scores from the present score of each server if the available memory capacity is less than 100 MB, thereby changing the scores of each server.

In yet another example, the resources consumption predictor 130 may be implemented to add 20 scores to the present score of each server if available network capacity, i.e. the capacity of available network, is greater than or equal to 10 Mbps which is changed in a case where the game, which has been requested to be executed by the client device 400, is newly allocated to each of the servers 300; or to subtract 100 scores from the present score of each server if less than 5 Mbps, thereby changing scores of each server.

In yet another example, if a game identical to the game, which has been requested to be executed by the client device 400, is allocated at present to the server 300, the resources consumption predictor 130 may add 20 scores to the present score of the server, thereby changing the scores of each server.

A server selector 140 selects a server which has the minimum load based on resources consumption when the game, which has been requested to be executed by the client device 400, is allocated to each of the servers 300, wherein the resources consumption has been predicted by the resources consumption predictor 130.

For example, the server selector 140 may be implemented to predict capacity of available resources of each server based on the resources consumption that is to be expected when the game, which has been requested to be executed by the client device 400, is allocated to each server; and select a server, which has been predicted to have maximum capacity of available resources, as a server with the minimum load.

In another example, the server, which has been predicted to have the maximum capacity of available resources, may be a server with the highest score among the servers 300 whose scores are changed according to a load amount fluctuated in a case where the game, requested to be executed by the client device 400, is newly allocated to each of the servers 300.

By these operations, according to the exemplary embodiments, the load balancer 100 of the load balancing system for a rendering service in a cloud gaming environment predicts the load of the servers 300, and selects a server with the minimum road, where the game is to be allocated.

In yet another example, the server selector 140 may be implemented to transmit information of the selected server with the minimum load to the client device 400 that has requested to execute the game. Moreover, the server selector 140 may be implemented to further transmit the rendering speed information on the game of the selected server with the minimum load to the client device 400 that has requested to execute the game.

In yet another example, the server selector 140 may be implemented to transmit frame per second (FPS) information that is different for each game as the rendering speed information. Here, the rendering speed information may be set in advance.

In yet another example, in a case of racing and shooting games where high FPS equates to high satisfaction levels of users, the load balancing system may be implemented to set the FPS relatively high. However, in a case of adventure and puzzle games where users may have high satisfaction even with relatively low FPS, the load balancing system may be implemented to set the FPS relatively low. Here, since a high level of FPS results in a large amount of resources consumption, the FPS may be set with a minimum value for each game within a range where the user's satisfaction is ensured.

By such operations, when the load balancer 100 of the load balancing system predicts the load of the servers and allocates the game to a specific server, the load balancing system may provide an appropriate rendering speed for each game to the client device 400, thereby providing users with a satisfactory game service and enabling efficient use of limited resources.

In an additional aspect of the exemplary embodiment, the resources consumption predictor 130 may be implemented to further reflect information of a reserved game whose load has not yet been monitored although the game has already been allocated to each server, and to predict anticipatory resources consumption that is to be expected when the game, which has been requested to be executed by the client device 400, is allocated to each server.

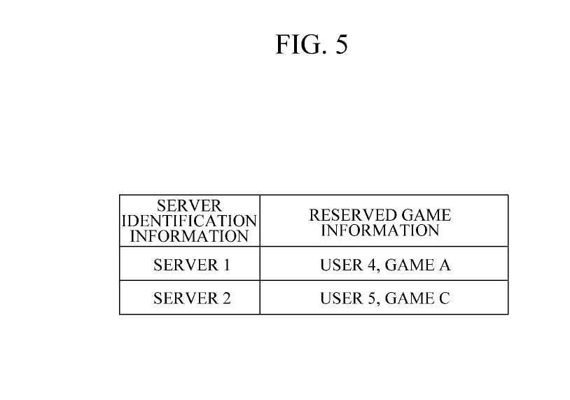

For example, the reserved game information may include server identification information on a server where the reserved game is to be allocated; and game identification information on the reserved game; and client identification information on a client device which has requested to execute the reserved game, as illustrated in FIG. 5. FIG. 5 is a diagram illustrating an example of reserved game information according to an exemplary embodiment.

If monitored is the load caused by a game that includes the game identification information that is included within the reserved game information, the resources consumption predictor 130 may be implemented to delete information related to the game where the load is monitored in the reserved game information.

By such an operation, the exemplary embodiment may consider games with load that has been caused by an allocation of a game, but that has not yet been monitored even though the game service has already been allocated to a specific server, and predict a load state of the server, thereby preventing the specific server from being in an overload state.

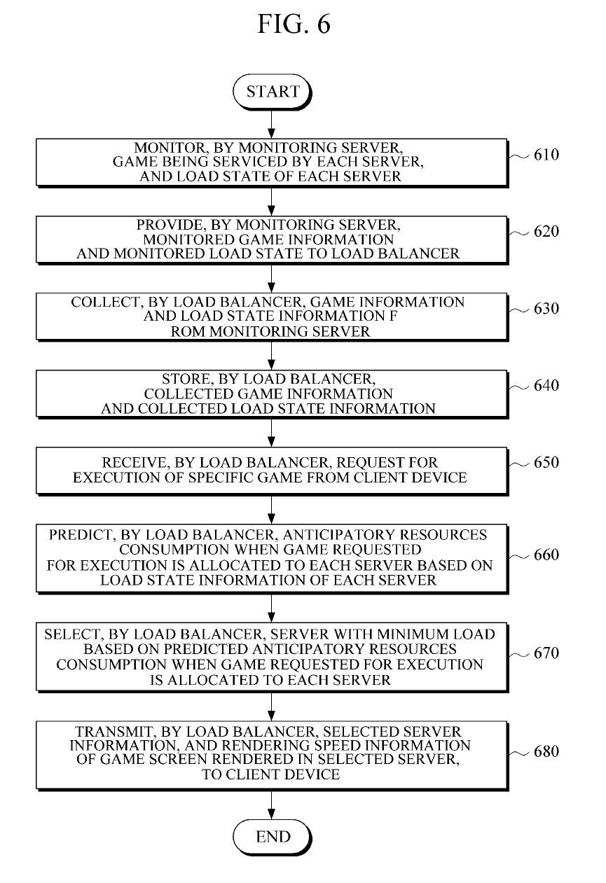

According to the exemplary embodiments as described above, shown in FIG. 6 is a load balancing operation of a load balancing system for a rendering service in a cloud gaming environment. FIG. 6 is a flowchart illustrating an example of a load balancing method of a load balancing system for a rendering service in a cloud gaming environment according to an exemplary embodiment.

First, in monitoring operation 610, a monitoring server monitors a game, which is being serviced by each server, and a load state of each server.

Then, in operation 620 of providing information, the monitoring server provides, to a load balancer, the game information being serviced by each server, and the load state of each server, which have been monitored in the operation 610.

Then, in operation 630 of collecting information, the load balancer collects, from the monitoring server, the game information being serviced by each server, and the load state information of each server.

Then, in operation 640 of storing information, the load balancer stores the game information being serviced by each server, and the load state information of each server, which have been collected in the operation 630.

In this state, in operation 650 of requesting an execution of a game, the load balancer receives a request for an execution of a specific game from a specific client device if the specific client device requests an execution of the specific game

Then, in operation 660 of predicting resources consumption, the load balancer predicts, based on the load state information of each server stored in the operation 640, anticipatory resources consumption that is to be expected when a game, which has been requested to be executed in the operation 650, is allocated to each server. The description about predicting the anticipatory resources consumption of the load balancer has been mentioned above, so the repeated description is omitted.

Then, in operation 670 of selecting a server, the load balancer selects a server with the minimum load based on the resources consumption when the game requested to be executed is allocated to each server, wherein the resources consumption has been predicted in the operation 660. The description about selecting the server has been mentioned above, so the repeated description is omitted.

Then, in operation 680 of transmitting information, the load balancer transmits, to the client device, information on the server selected in the operation 670 and rendering speed information on a game screen rendered in the selected server.

By these operations, when predicting load of servers and allocating a game to a specific server, the exemplary embodiments of a load balancing system for a rendering service in a cloud gaming environment provides an appropriate rendering speed to the client device for each game, thereby providing users with a satisfactory game service and enabling efficient use of limited resources. Thus, the above-mentioned purpose of the load balancing system and method may be achieved.

The methods and/or operations described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing a higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A load balancing system for a rendering service in a cloud gaming environment, the load balancing system comprising:
a load balancer configured to select, based on a load state of each server and anticipatory resources consumption for each game, a server where a game which has been requested to be executed by a client device is to be allocated, and transmit, to the client device, information on the selected server and rendering speed information on a game screen rendered in the selected server; and
a monitoring server configured to monitor a game, which is being serviced by each server, and a load state of each server, and provide information on the monitored game and information on the monitored load state to the load balancer.

2. The load balancing system of claim 1, the load balancer comprises:
an information collector configured to collect the information on the game, which is being serviced by each server, and the information on the load state of each server from the monitoring server;
information storage configured to store the information on the game, which is being serviced by each server, and the information on the load state of each server, wherein both are collected by the information collector;
a resources consumption predictor configured to, based on the information on the load state of each server, which has been stored in the information storage, predict the anticipatory resources consumption that is to be expected when the game, which has been requested to be executed by the client device, is to be allocated to each server; and
a server selector configured to select a server with minimum load based on the anticipatory resources consumption predicted by the resources consumption predictor.

3. The load balancing system of claim 2, wherein the server selector is configured to transmit information on the selected server with minimum load to the client device which has requested to execute the game.

4. The load balancing system of claim 3, wherein the server selector is configured to further transmit the rendering speed information on the game of the selected server with minimum load to the client device which has requested to execute the game.

5. The load balancing system of claim 2, wherein the information on the game comprises:
unique game identification information for identifying each game;
consumed Central Processing Unit (CPU) capacity information of a time when each game is allocated to each server;
consumed Graphics Processing Unit (GPU) capacity information of the time when each game is allocated to the server;
consumed memory capacity information of the time when each game is allocated to the server;
consumed network capacity information of the time when each game is allocated to the server; and
rendering speed information of the time when each game is allocated to the server.

6. The load balancing system of claim 2, wherein the information on the load state comprises:
unique server identification information for identifying each server;
IP address information in which IP addresses of each server are recorded;
CPU information in which CPU capacity and CPU load of each server are recorded;
GPU information in which GPU capacity and GPU load of each server are recorded;
memory information in which memory capacity and memory usage of each server are recorded;
network information in which network capacity and network usage of each server are recorded; and
game allocation information in which recorded are game identification information of a game allocated at present to each server, rendering speed information of the allocated game, and client identification information for identifying the client device which has requested to execute the allocated game.

7. The load balancing system of claim 2, wherein the server selector is configured to:
predict capacity of available resources of each server based on resources consumption that is to be expected when the game, which has been requested to be executed by the client device, is allocated to each server; and
select a server, which has been predicted to have maximum capacity of available resources, as a server with the minimum load.

8. The load balancing system of claim 4, wherein the server selector is configured to transmit frame per second (FPS) information for each game as the rendering speed information.

9. The load balancing system of claim 2, wherein the rendering speed information is set in advance.

10. The load balancing system of claim 2, wherein the resources consumption predictor is configured to:
further reflect information of a reserved game whose load has not yet been monitored although the game has already been allocated to each server; and
predict the anticipatory resources consumption that is to be expected when the game, which has been requested to be executed by the client device, is allocated to each server.

11. The load balancing system of claim 10, wherein the reserved game information comprises:
server identification information on a server where the reserved game is to be allocated;
game identification information on the reserved game; and
client identification information on the client device which has requested to execute the reserved game.

12. A load balancing method for a rendering service in a cloud gaming environment, the load balancing method comprising:
monitoring, by a monitoring server, a game being serviced by each server and a load state of each server;
providing, by the monitoring server, monitored information on the game and monitored information on the load state to a load balancer;
collecting, by the load balancer, the information on the game and the information on the load state from the monitoring server;
storing, by the load balancer, the collected information on the game and the collected information on the load state;
receiving, by the load balancer, a request for an execution of a specific game from a client device;
based on the stored information of the load state, predicting, by the load balancer, anticipatory resources consumption that is to be expected when the game which has been requested to be executed is allocated to each server;
selecting, by the load balancer, a server with minimum load based on the predicted resources consumption of a time when the game which has been requested to be executed is allocated to each server; and
transmitting, by the load balancer, information on the selected server and rendering speed information on a game screen rendered in the selected server to the client device.
